(19) United States
(12) Patent Application Publication
(10) Pub. No.: US 2014/0304584 A1
(43) Pub. Date: Oct. 9, 2014

(54) Computer-Implemented System and Method for Generating and Sharing Sports Statistics

(71) Applicant: Cameron Taylor, Calgary (CA)

(72) Inventor: Cameron Taylor, Calgary (CA)

(21) Appl. No.: 13/856,463

(22) Filed: Apr. 4, 2013

(51) Int. Cl. G06F 17/22; G06F 17/30

(52) U.S. Cl. CPC G06F 17/2247; G06F 17/30312; G06F 17/30864
USPC 715/234

(57) ABSTRACT

A computer-implemented method and system for generating sports statistics and sharing sports statistics on a website includes a statistic creation manager configured to access a database of sports data, to receive user selections as a function of the sport data, and upon receiving the user selections to generate a sports statistic as a function of those user selections a statistic feed manager configured to tag the sports statistic with one or more received user selections to permit display of the sports statistic on the website as a function of the tag.

### FIELD OF THE INVENTION

The present invention relates generally to systems and methods for generating and visualizing sports statistics, and more particularly, relating to an Internet based system and method for generating, visualizing, and sharing sports statistics in a social network environment.

### BACKGROUND OF THE INVENTION

For a myriad of reasons sports enthusiasts desire to compile, review, visualize, and share sports statistics. Sports statistics may vary from relatively simple individual player statistics, such as game-winning goals to more complex individual player statistics, such as power-play game-winning goals during a player's career or during a specified time period or against a specified team. Sports statistics may also vary from relatively simple team statistics, such as the number of team wins to more complex team statistics, such as the number of team wins with shootouts or number of team wins against a specified team.

Unfortunately, however, the vast majority of sports enthusiasts do not have the ability to process such a vast collection of raw statistical data to create meaningful and accurate sports statistics, and thus, are left to rely upon professional sports statisticians to create and publish sports statistics they deem appropriate. Typically, sports enthusiasts must turn to websites of major broadcasting companies, such as FOX, CBS, and ESPN to view the professionally created statistics that are made available at these websites. This is undesirable to sports enthusiasts for a number of reasons. For one, professionally created sports statistics may not be related to or include the specific statistic the sports enthusiast desires. Further, the vast majority of professionally created sports statistics are not readily available to the sports enthusiast. And even when they are available, they are located across multiple, unrelated and non-centralized platforms making access to the statistics a tedious and time consuming chore, even for the most diehard enthusiast. Additionally, sports enthusiasts desire to communicate to share their thoughts and opinions with other enthusiasts about sports statistics.

Accordingly, a need exists for an Internet based platform that provides an acceptable system and method in which internet users may access and create, share, and discuss sports statistics of players and teams of various sports.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the present invention provide a computer-implemented method and system comprising an internet-based software application having an internet website user interface that provides a platform for users to create, analyze, and share user specified sports statistics.

In one embodiment, a computer-implemented system for generating and sharing sports statistics on a website comprises a statistic creation manager configured to access a database of sports data, to receive user selections as a function of the sport data, and upon receiving the user selections to generate a sports statistic as a function of those user selections and a statistic feed manager configured to tag the sports statistic with one or more received user selections to permit display of the sports statistic on the website as a function of the tag.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a diagram of the computer-implemented sports statistic generating and sharing system in accordance with an embodiment of the present invention;

FIG. 2 is a diagram of software modules or applications in accordance with an embodiment of the present invention;

FIG. 3 is a diagram of a player query software module in accordance with an embodiment of the present invention;

FIG. 4 is a diagram of a team query software module in accordance with an embodiment of the present invention;

FIG. 5 is an exemplary player statistic output chart generated utilizing the software modules of embodiments of the present invention;

FIG. 6 is an exemplary team statistic output chart generated utilizing the software modules of embodiments of the present invention;

FIG. 7 is a an exemplary structure of a statistic feed database supported by a database server in accordance with an embodiment of the present invention;

FIG. 8 is an exemplary structure of a user database supported by a database server in accordance with an embodiment of the present invention;

FIG. 9 is an exemplary structure of a sports statistic post database supported by a database server in accordance with an embodiment of the present invention;

FIG. 10 is an exemplary structure of a user name database supported by a database server in accordance with an embodiment of the present invention;

FIG. 11 is a diagram of an exemplary website user interface in accordance with an embodiment of the present invention; and

FIG. 12 is a diagram of an exemplary website structure in implementing various aspects of embodiments of the present invention.

### DETAILED DESCRIPTION OF THE INVENTION

As a preliminary matter, the embodiments of the invention and their various features and advantages are explained more fully with reference to the non-limiting embodiments and examples that are described and/or illustrated in the accompanying drawings and detailed in the following description. The embodiments discussed herein are to be considered an exemplification of the principles of the invention, and are not intended to unnecessarily limit the broad aspects of the invention to the embodiments illustrated and discussed herein.

The present invention is directed towards a system comprising an internet-based software application having an internet website user interface that provides a platform for users to create, analyze, and share user specified sports statistics. The system provides a user with the ability to create specified sports statistics or comparative data of individual athletes and team performances having predefined constraints that are selected by the user in the process of outputting the specified sports statistics. Moreover, the system provides a web-based social networking platform upon which users may share their personally created sports statistics and communicate with other users. Users may comment upon and/or rank the shared sports statistics. The social networking platform also provides an interface to permit users of the system to search for other user generated and shared sports statistics. The social networking platform also provides a share feed of user generated sports statistics that may be populated by any number of filters such as, user ranking, user viewing frequency, popularity, relevance to sporting events, etc. Further, users may filter the share feed, for example, by the same filters or other filters to meet their personal preferences.

The system and related software operates to generate a website base interface that may include different sections, each corresponding to a sporting event or sport type. The sections may include, for example, hockey, baseball, football, and basketball sections. Of course other sections may be provided for any number of sporting events or sports. While visiting a section of the website corresponding to a particular sport, a user may generate sports statistics of specified players or teams over a period of time. For example, a user visiting the hockey section of the website can generate a statistic of the number of goals per game that American forwards scored compared to Canadian forwards during each month of a regular season. The generated statistic may then be shared with other users of the website via the share feed or other users may discover the generated statistic upon conducting a search of user shared statistics as will be discussed in further detail below.

In preferred embodiment, the software of the invention is accessed through the Internet 19 using computing devices 18. As will be appreciated by one of ordinary skill in the art, the Internet comprises numerous numbers of computing devices and communication networks that are interconnected through communication links. The computer program for creating and sharing sports statistics is accessed via a web page, and is described in more detail below.

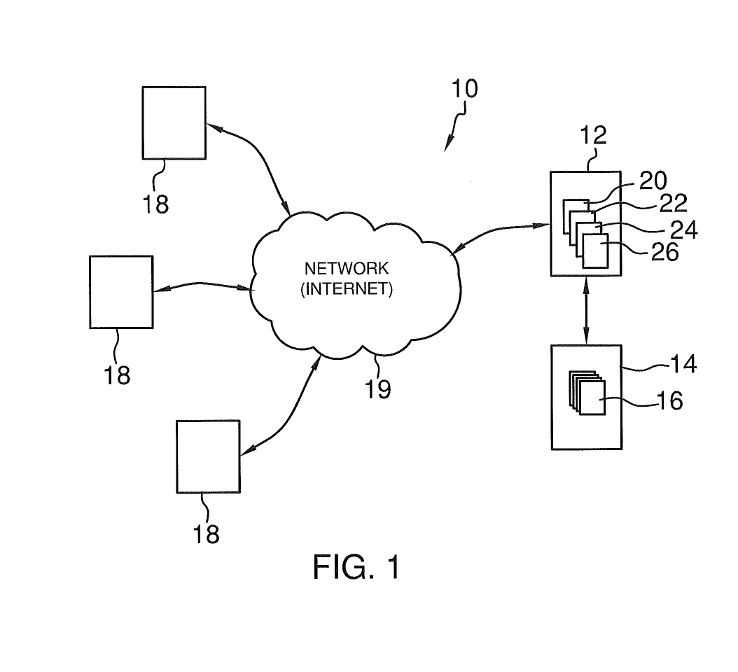

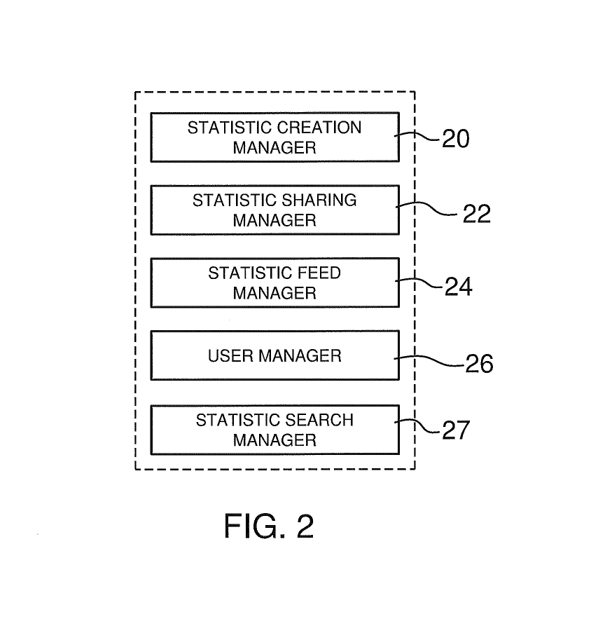

Referring to FIG. 1, the system 10 is comprised of an application server 12 hosting the website user interface, website social network, and related software modules, a database server 14 hosting a software relational database 16, and one or more network enabled user computing devices 18 that are capable of operating a standard internet web browser, such as, for example, Internet Explorer, Firefox, Opera, Opera mini, Safari, Google Chrome, and the like. The database server 14, relational database 16, and the application server 12 work in concert to receive, collect, organize, process, maintain, and output data to users through the website user interface and website social network. One of ordinary skill in the art will readily appreciate that other system arrangements are possible while maintaining the functionality and method of the website user interface and website social network within the principals of this invention. Accordingly, the invention should not be limited to the specific system architecture described herein.

The database server 14, the relational database 16, and the application server 12 support a plurality of subsystems and related software modules and code segments, the first being the Statistic Creation Manager 20, the second being the Statistic Sharing Manager 22, the third being the Statistic Feed Manager 24, the fourth being a User Manager 26, and the fifth being a Statistic Search Manager 27, each of which can work separately or together, and are discussed individually in further detail below.

The relational database 16 may include several related databases for implementing the system 10, including a raw statistics database including raw sports statistical data, user database including user profile information, user created statistics database including all statistics created by users, a post database, query control database, and any other database required to implement the system.

Statistic Creation Manager

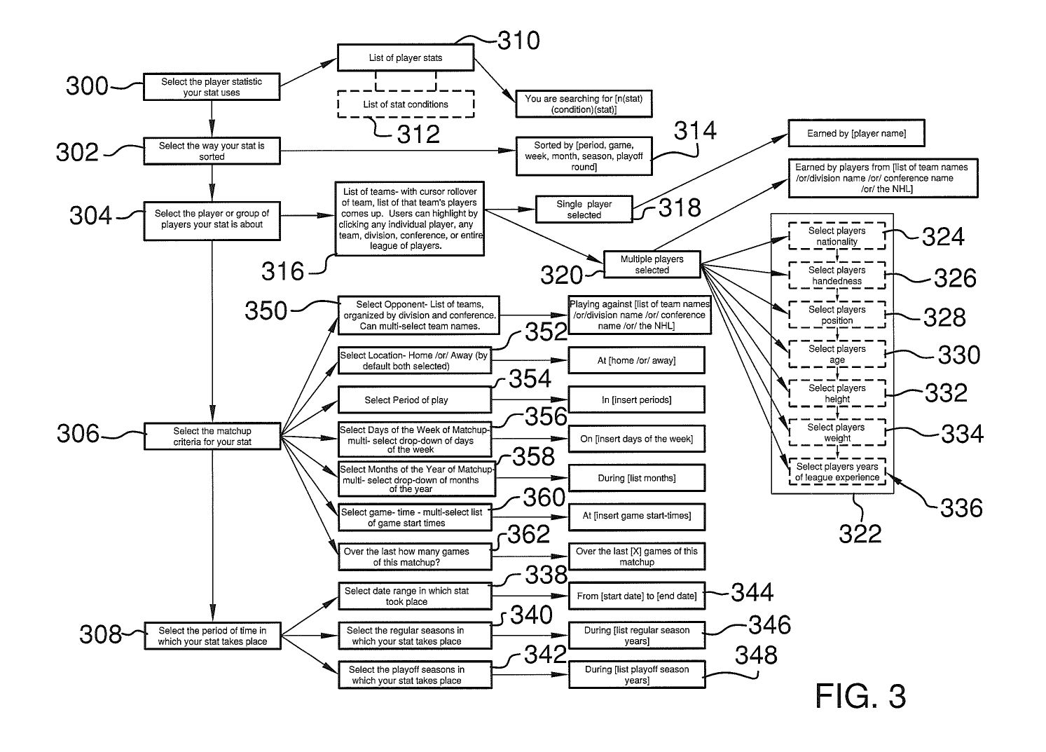

The Statistic Creation Manager 20 module or software code segment includes three sections, the first being a player statistic creation query (player query) 28 depicted in FIG. 3, the second being a team statistic query (team query) 30 depicted in FIG. 4, and the third being a statistic output function. The player query 28 operates to create user specified sports statistics centered on individual player statistical data that is stored in database 16, e.g. the player query is a tool that functions to guide a user in building a defined database query to return a desired player statistical output. The player query 28 includes a plurality of predefined criterion, each including a related subset of selectable predefined or semi-predefined criterion under which a user makes selections to create a database query to operate upon database 16 to generate the desired player statistic. The predefined criterion includes Player Statistic 300, Statistic Sort 302, Player Selection 304, Matchup 306, and Time Period 308.

Player Statistic 300 refers to any piece of data collected for a player throughout the course of a game. By way of example, and in non-limiting reference to hockey, selectable player statistics may include:

Goals

Assists

Penalties

Penalty Minutes

Position

Games

Power Play Goals

Shots on Goal

Shooting Percentage

Shorthanded Goals

Shorthanded Assists

Game Tying Goals

Empty Net Goals

Time on Ice

Games Started

Goals Against

Saves

To make this selection, a user through the website user interface, would cursor over or click the Player Statistic 300 resulting in a dropdown box or listing 310 of selectable player statistics, such as the statistic data points listed above. A selected statistical data point may be modified by a Stat Condition 312. Oftentimes, statistic relations are modified in some manner, for example, goals per game. To capture this, a selected statistical data point can be given modifiers, such as [+, −, /, <, >, =, within which]. If a user selects a condition, the user is prompted with another statistic data dropdown or list. For example, a user desiring a statistic on goals per game would first select the statistical data point [goals] followed by modifier [/ or per] and then select the statistical data point games.

Statistic Sort 302 refers to way the created statistic will be sorted upon output. By way of example, and in a non-limiting reference, selectable sort modifiers include:

By Game

By Week

By Month

By Season

By Playoff Round

Best

Top 5

Top 10

Top 20

Worst

Bottom 5

Bottom 10

Bottom 20

To make this selection, a user through the website user interface, would cursor over or click the Statistic Sort 302 resulting in a dropdown box or listing 314 of selectable sort modifiers, such as those listed above.

Player Selection 304 refers to the selection of an individual player or multiple players that the statistic will be created for. The player selection is a hierarchical list of players ordered, for example, by teams, divisions, conferences, league or any other suitable order as based upon the sport. To make this selection, a user through the website user interface, would cursor over or click the Player Selection 304 resulting in a dropdown box or listing 316. For example, a list of all the teams in the league, sorted by division and conference is presented to the user. By selecting or moving the cursor over a specific team, a list of that team's players is populated in a secondary dropdown box or listing. A single player 318 may be selected or any number of players or groups of players 320 may be selected by selecting the individual players or by selecting an entire team, divisions, conferences, or the entire league. For example, a selection of one or more divisions would result in a selection of each player in the selected one or more divisions. A search feature is also provided that permits the searching of a particular selection by name, for example, player name, team name, division name, etc.

If more than one player is selected, a selected player list 320 is populated which may be further refined by selecting player group modifier criteria 322 for the group of players. The player group modifier criteria selections are not mutually exclusive, allowing multiple selections. By way of example, and in a non-limiting reference, selectable player group modifiers include:

Nationality 324

Handedness 326

Position 328

Age 330

Height 332

Weight 334

Years of League Experience 336

Matchup 306 provides the user with the ability to further drill down the desired statistic. If the user wants to know how a player performs against a specific team or teams, the user would select the specific opponent(s) by team name using the Select Opponent 350 query control. For example, a user wants to know how many goals Sidney Crosby has scored in his career against the Philadelphia Flyers. The Flyers would be selected as the opponent for this particular statistic. Within this control, teams are organized by conference and division so that users can quickly select entire divisions or conferences if the user wants to know how a player or players perform against specific divisions or conferences.

Likewise, if the user wants to know how a player or players perform at home or away games, either “Home” or “Away” can be selected under the Select Location 352 query control. If a user wants to know how a player or players perform in a specific period (or quarter) of play, the player can select one or multiple periods 354. If a user wants to know how a player or players perform at a specific game time, on a specific day of the week, or during a specific month of the year, there are query controls that allow for these selections as well, namely select Days of the Week 356, select Month of the Year 358 and select Game-Time 360. Finally, if a user wants to know how a player or players have performed over the last x number of games 362, there is a query control that allows user to set this number. All of the Matchup Criteria controls can be used independently or in conjunction with one another.

The potential importance of these criteria is discussed. The home team advantage is a well-known phenomenon in sports. Thus, differentiating between home and away games is an important criterion that users may want to include when creating a statistic. How players perform at different game starting times, on specific days of the week, or during specific months of the year is less known, but these could very well affect the performance of certain players and teams. Since the query tool aims to allow for as much flexibility as possible when creating a statistic, these criteria are available to users.

Time Period 308 refers to period of time across which the created statistic will span. By way of example, and in a non-limiting reference, selectable time periods include:

Date Range 338

Season 340

Playoff 342

If Date Range 338 is selected, the user is prompted at 344 to enter a starting date and an ending date. If Season 340 is selected, the user is prompted at 346 to enter or select season years. If Playoff 342 is selected, the user is prompted at 348 to enter or select the playoff season years.

The player query 28 may also include a comparison function that operates to compare a completed player statistical query against one more additional completed player statistical queries. The comparison function operates to generate and display a second player query set that is a copy from the first completed player statistical and includes identical selections made in the first player query set. Users then are able to change selections in the second player query set to create the desired comparison.

For example, in operation, a user may utilize the player query 28 to build a database query to generate a statistical output comparing the number of goals scored per game by Americans with the number of goals scored per game by Canadians on a monthly basis. In this example, under Player Statistic 32, the user would select [goals] followed by the selection of the Stat Condition modifier [/] followed by the selection of [games]. Under Statistic Sort 34, the user would select the sort modifier [by month]. Under Player Selection 36, the user would select the entire NHL league or [NHL]. Because more than one player is selected through the selection of the entire NHL, the user would set the Nationality under the player group modifier criteria 52 to [American]. Matchup 38, Opponent, Location, Periods of Play, Game Day, and Game Start-Time are each selected to [all] either by default or user selection because the matchup for this desired statistic includes all games, at all locations, on any day of the week and at any start-time. Time Period 38, the user would select [Season] to the 2011-2012 season. Once this is completed, the user would initiate the “Add Comparison” function and then change the Nationality under the player group modifier criteria 52 to [Canadian].

As the user is inputting the query controls, the player query generates a written list of the criteria the user has selected. This is presented to the side of the query controls, and acts to ensure the user he is searching for the statistic he intends to generate. This is demonstrated in FIG. 3 The player query's textual output, in coordination with the selected criteria, works as follows:

“You are searching for”

[selected stat][condition][stat]

“sorted by”

[sort type]

“earned by”

[player name], or

players from [list of team names /or/ division name /or/ conference name /or/ the NHL] who are [nationality, handedness, position, age, height], weigh [x] pounds (with [x] years of experience /or/ who are [rookies /or/ sophomores])

“Playing”

[at home /or/ away] in [insert periods] against [list team names /or/ division /or/ conference] on [list days of the week] at [list game start-times]

“From”

([start date] to [end date])

and/or

“During”

the [list season year] season(s)

the [list playoff season year] playoff season(s)

and/or

“Over”

the last [x] games

“And comparing this to”

repeat process with second stream of controls.

Using the previous example, the textual output generated as the user is selecting criteria would be: “You are searching for goals/game sorted by month earned by players from the NHL who are American during the 2011-2012 season and comparing this to goals/game sorted by month earned by players from the NHL who are Canadian during the 2011-2012 season.” Note that in this example the Matchup Criteria does not show up in the textual output as these controls remained at their default setting.

Once the user is satisfied with the built database query the user would submit the query, for example, by pressing or selecting a submit button or icon in the user interface, and then system 10 operates the submitted query upon database 16 to generate the desired statistic. As will be described in further detail below, the statistic may be outputted as a textual result, a graphical result, or both.

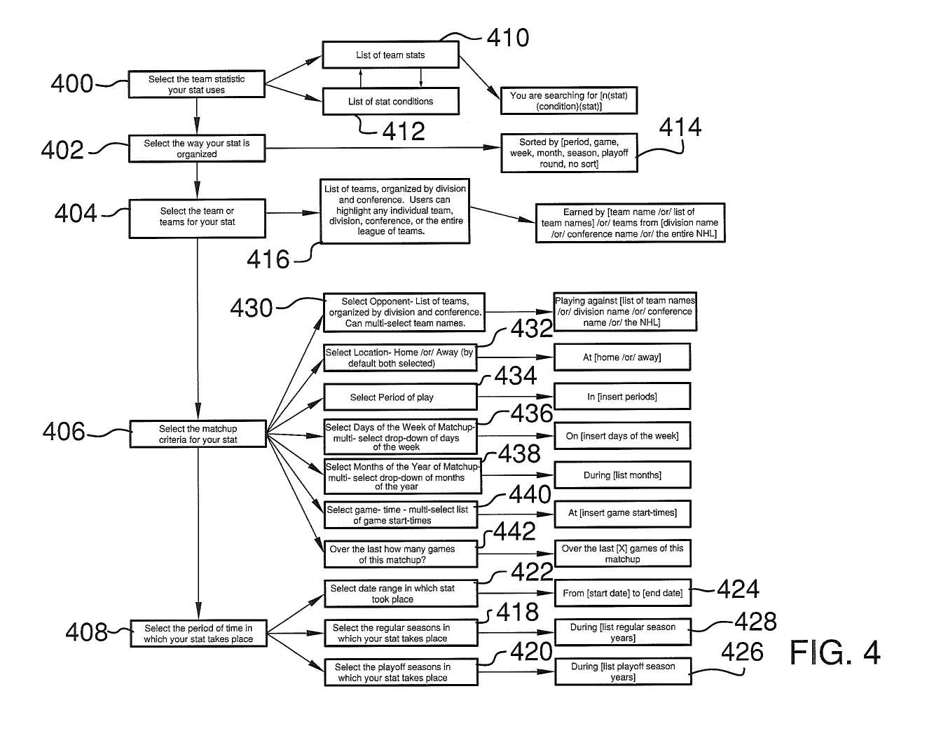

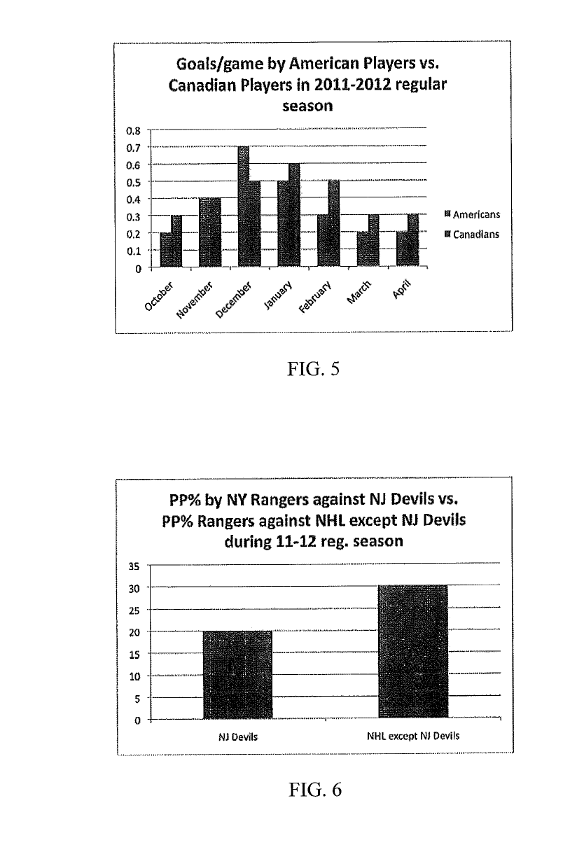

To generate a textual result (not to be confused with the textual output, described above) the query tool forms a sentence using the selected criteria in the following order: Time Criteria, Player Criteria, Stat and Stat Condition, Matchup Criteria. Further comparative query streams are presented as their own sentences, following the first query stream sentence. The Statistic Sort is not conveyed in the textual output. It is only used in the graphical result. Using the above example, the textual result for this statistic is “During the 2011-2012 season Americans earned 0.4 goals/game. During the 2011-2012 season Canadians earned 0.3 goals/game.” An example graphical output is depicted in FIG. 5.

In cases where the sort criteria is selected as [Best, Worst, Top, Bottom], the textual result presents only the first player in the list (the graphical result would present the entire list, for example a table with the Top 10 players in a given statistical category, if the sort was selected as [Top 10]). An example textual result would be: “During the 2011-2012 season, Steven Stamkos earned 20 powerplay goals, the most of any player.” Note that if the sort is selected to be [Best, Top 5, Top 10, Top 20], “the most of any player” is added to the end of the textual result's sentence. If the sort is selected as [Worst, Bottom 5, Bottom 10, Bottom 20], “the least of any player” is added to the end of the textual result's sentence. The textual result can be edited by the user before being posted to the Statistic Feed.

With reference to FIG. 4, the team query 30 is similarly structured to the player query 28, and operates to create user specified sports statistics centered on team statistical data stored in database 16, e.g. the team query is a tool that functions to guide a user in building a defined database query to a desired team statistical output. Like the player query, the team query also includes a plurality of predefined criterion, each including a related subset of selectable predefined or semi-predefined criterion under which a user makes selections to create a database query for operation upon database 16 to generate the desired team statistic output. The predefined criterion includes Team Statistic 400, Statistic Sort 402, Team Selection 404, Matchup 406, and Time Period 408.

Team Statistic 400 refers to any piece of data collected for a team throughout the course of a game. By way of example, and in non-limiting reference to hockey, selectable team statistical data may include:

Games Played

Wins

Losses

Ties

Overtime Losses

Shootout Losses

Points

Goals

Goals against

Shutouts

Powerplay Goals

Powerplay Opportunities

Powerplay Percentage

To make this selection, a user through the website user interface, would cursor over or click the Team Statistic 400 resulting in a dropdown box or listing 410 of selectable team statistics, such as the statistic data points listed above. A selected statistical data point may be modified by a Stat Condition 412. Oftentimes, statistic relations are modified in some manner, for example, powerplay percentage. To capture this, a selected statistical data point can be given modifiers, such as [+, −, /, <, >, =, within which]. If a user selects a condition, the user is prompted with another statistic data dropdown or list. For example, a user desiring a statistic on team powerplay percentage would first select the statistical data point [Powerplay Goals] followed by modifier [/ or per] and then select the statistical data point [Powerplay Opportunities]. It's also possible that a user is able to simply initially select the statistic Powerplay Percentage since this is a data point in the database 16.

Statistic Sort 402 refers to way the created statistic will be sorted upon output. By way of example, and in a non-limiting reference, selectable sort modifiers include:

By Game

By Week

By Month

By Season

By Playoff Round

Best

Top 5

Top 10

Top 20

Worst

Bottom 5

Bottom 10

Bottom 20

To make this selection, a user through the website user interface, would cursor over or click the Statistic Sort 402 resulting in a dropdown box or listing 414 of selectable sort modifiers, such as those listed above.

Team Selection 404 refers to the selection of an individual team or multiple teams for which the statistic will be created. The team selection is a hierarchical list of teams in the league ordered, for example, by division and conference. To make this selection, a user through the website user interface, would cursor over or click the Team Selection 404 resulting a in a dropdown box or listing 416. For example, a list of all the teams in the league, sorted by division and conference is presented to the user. Any number of teams may be selected from the list by selecting individual teams, a division, conference, or the entire league. For example, a selection of one or more divisions would result in a selection of each team in the selected one or more divisions.

Matchup 406 provides the user with the ability to further drill down the desired statistic and operates similarly to Matchup 306 as discussed above. That is, Matchup 406 permits the user to make various criteria selections to further define or drill down the desired statistics. As in Matchup 306, Matchup 406 allows selection of Opponent 430, Location 432, Period of Play 434, Days of the Week 436, Months of the Year 438, Game Time 440, and Games 442.

Time Period 408 refers to period of time across which the created statistic will span. By way of example, and in a non-limiting reference, selectable time periods include:

Season 418

Playoff 420

Date Range 422

If Date Range 422 is selected, the user is prompted at 424 to enter a starting date and an ending date. If Playoff 420 is selected, the user is promoted at 426 to enter or select playoff season years. If Season 418 is selected, the user is prompted at 428 to enter or select the season years.

The team query 30 may also include a comparison function that operates to compare a completed team statistical query against one more additional completed team statistical queries. The comparison function operates to generate and display a second team query set that is a copy from the first completed team statistical and includes identical selections made in the first team query set. Users then are able to change selections in the second team query set to create the desired comparison.

For example, in operation, a user may utilize the team query 30 to build a database query to generate a statistical output comparing the Powerplay Percentage of the New York Rangers when playing against the New Jersey Devils during the 2011-2012 regular season. The user further wants to compare the New York Rangers' Powerplay Percentage against the remaining league.

In this example, under Team Statistic 400, the user would select [Powerplay Goals] followed by the selection of the Stat Condition modifier [/] followed by the selection of [Powerplay Opportunities]. Alternatively, the user may select directly [Powerplay Percentage] if it is an available selection. Under Statistic Sort 402, the user would select the sort modifier [none] (the default). Under Team Selection 404, the user would select [New York Rangers]. Under Matchup 406, the user would select [New Jersey Devils] under the Opponent selection and then the remaining selections Location, Periods of Play, Game Day, and Game Start-Time are each selected to [all] either by default or user selection because the matchup for this desired statistic includes all games, at all locations, on any day of the week and at any start-time. Time Period 408, the user would select [Season] to the 2011-2012 season. Once this is completed, because the user also desires to “compare” the Rangers' Powerplay Percentage against the entire league, the user would initiate the “Add Comparison” function and then change the Opponent under Matchup to select all the teams except the New Jersey Devils.

As the user is inputting the query controls, the team query generates a written list of the criteria the user has selected. This is presented to the side of the query controls, and acts to ensure the user he is searching for the statistic he intends to generate. This is demonstrated in FIG. 4 The player query's textual output, in coordination with the selected criteria, works as follows:

“You are searching for”

[selected stat][condition][stat]

“sorted by”

[sort type]

“earned by”

[team name(s)], or

teams from [division name /or/ conference name /or/ the NHL]

“Playing”

[at home /or/ away] in [insert periods] against [list team names /or/ division /or/ conference] on [list days of the week] at [list game start-times]

“From”

([start date] to [end date])

and/or

“During”

the [list season year] season(s)

the [list playoff season year] playoff season(s)

and/or

“Over”

the last [x] games

“And comparing this to”

repeat process with second stream of controls

Using the previous example, the textual output generated as the user is selecting criteria would be: “You are searching for powerplay percentage earned by the New York Rangers playing against the New Jersey Devils during the 2011-2012 season and comparing this to the powerplay percentage earned by the New York Rangers playing against the NHL except the New Jersey Devils during the 2011-2012 season.

Once the user is satisfied with the built database query the user would submit the query, for example, by pressing or selecting a submit button or icon in the user interface, and then system 10 operates the submitted query upon database 16 to generate the desired statistic.

As will be described in further detail below, the statistic may be outputted as a textual result, a graphical result, or both. To generate a textual result (not to be confused with the textual output, described above) the query tool forms a sentence using the selected criteria in the following order: Time Criteria, Team Criteria, Stat and Stat Condition, Matchup Criteria. Further comparative query streams are presented as their own sentences, following the first query stream sentence. The Statistic Sort is not conveyed in the textual output. It is only used in the graphical result. Using the above example, the textual result for this statistic is: During the 2011-2012 season, the New York Rangers earned 20% (5/25) powerplay effectiveness against the New Jersey Devils. During the 2011-2012 season, the New York Rangers earned 30% powerplay effectiveness (120/400) against all NHL teams except the New Jersey Devils. Note that if the sort is selected to be [Best, Top 5, Top 10, Top 20], “the most of any team” is added to the end of the textual result's sentence. If the sort is selected as [Worst, Bottom 5, Bottom 10, Bottom 20], “the least of any team” is added to the end of the textual result's sentence. The textual result can be edited by the user before being posted to the Statistic Feed. An example graphical output is depicted in FIG. 6.

Statistic Sharing Manager

The Statistic Sharing Manager 22 module or software code segment operates to customize statistics generated by the Statistic Creation Manager 20 prior to posting statistic to the statistics feed for sharing in the social network as will be further described below. The Statistic Sharing Manager 22 operates to provide various functions or tools to a user to permit the user to select from various types of graphs to pictorially display the created statistic and to edit the textual result of the statistic. Graphing software applications are well known in the field of the invention, and accordingly, the invention is not directed towards specific data graphing processes or methods, and any number of such graphing utilities may be implemented herein to provide the graphing functionality. For example, a suitable graphing utility is described in U.S. Patent Application Publication No. 2005/0001837, the entirety of which is incorporated herein by reference. One of ordinary skill in the art will readily appreciate that the utility described in this reference is merely one of a number of equally suitable applications that could be implemented herein, and thus, the invention is not limited solely to the utility described by this reference.

Once a user is satisfied with the graphical and/or textual output of the created statistic, the user through the graphical user interface (GUI) clicks on, selects, or otherwise causes the system 10 to store the created statistic in a statistic database that may be part of or separate from the raw sports statistical data base 16. Each created statistic is associated with an unique identifier for purpose of relating the statistic to a statistic feed database that is used in handling control of display and feed of each shared and posted statistic to the social network platform.

Statistic Feed Manager

The Statistic Sharing Manager 22 module or software code segment defines and tracks all posts of user created statistics in the social network on the statistic feed, a web feed of user shared statistics within the social network website application or section of system 10. Each user may customize how the statistic feed is populated and displayed to the user as will be described in further detail below. Posts are tracked and shared using a number of relational data segments, such as, for example, post id, poster's user name, date stamp, metadata, popularity, user shares, user comments, etc.

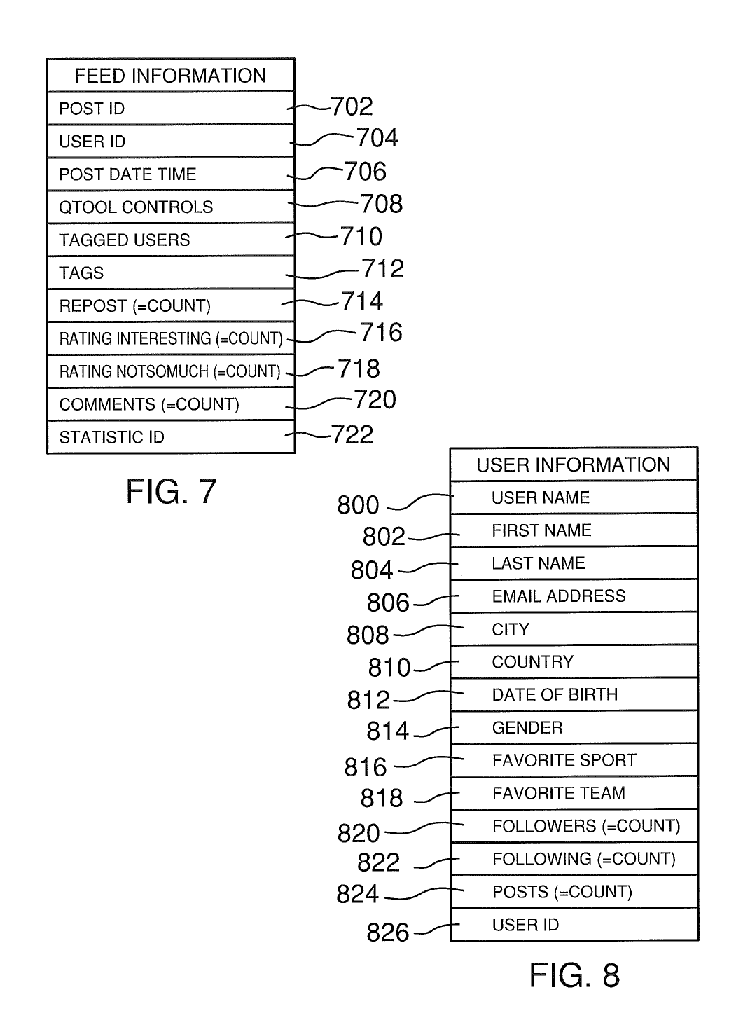

With reference to FIG. 7, there is illustrated an exemplary structure of a statistic feed database 700 supported by database server 14. The statistic feed database 700 includes relational information such as post id 702 a unique identifier for each user post, user_id 704 the unique user identifier of the user creating the post to be fed into the feed and which relates to the user profile such that user name, and other related information may be included and viewable to users in the feed, post stamp 706 the date and time the post is created, qtool controls 708 include attributes used to create the statistic, tagged users 710 include unique identifiers of other users related to the post and/or feed, tags 712 include user selectable information relating to the content of the post, repost (=count) 714 is the number of times the post has been reposted within the feed, rating interest (=count) 716 is the number of time users have giving a positive rating on the post, rating not so much (=count) 718 is the number of time users have giving a negative rating on the post, comments (=count) 720 is the number of times a comment has been made by a user about the post, statistic_id 722 is the unique identifier of the user created statistic that the post is related.

The qtool controls 708 and tags 712 are essentially metadata that are assigned to each created post of statistics within the social network and/or statistic feed that are used to described the content of the posted statistic such that the post can be found again by browsing or searching. The qtool controls 708 include criterion selected or entered by the user during the building of the database query that was used to generate the specific statistic. For example, if a generated statistic was a comparison of the number of goals scored per game by Sidney Crosby in his career against the Flyers with the number of goals scored per game by Alexander Ovechkin in his career against the Flyers, the qtool controls 708 may include “goals per game”, “Sidney Crosby”, “Alexander Ovechkin”, “Philadelphia Flyers”, and each and every season and playoff year Crosby and Ovechkin have played. The tags 712 is the user's selection of a number of the qtool controls 708 to be displayed in the post for viewing by users. For example, the user may select “Sidney Crosby”, “Alexander Ovechkin”, and “Philadelphia Flyers” to be displayed in the post to users.

Once a statistic has been posted, users may interact with the post in a number of ways, including sharing a post with their followers (other users that have selected to follow the users activities), commenting on a post, and rating post, such as, for example, “Interesting” or “Not so Much.”

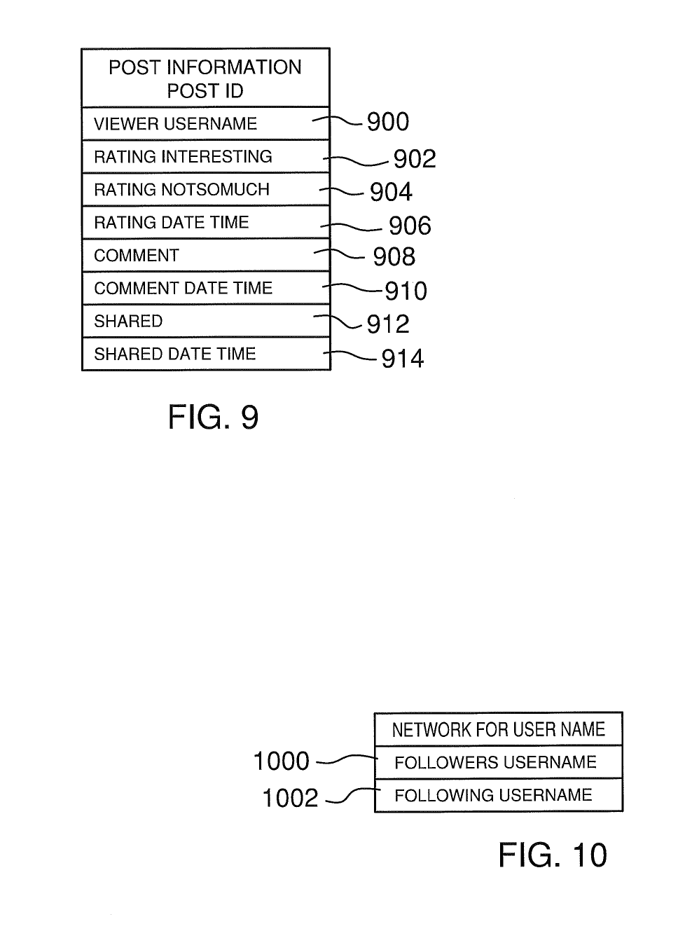

With reference to FIG. 9, post information such as, viewer user name 900, rating interesting 902, rating not so much 904, rating date and time 906, comment 908, comment date and time 910, shared 912, and shared date and time 914 are stored or maintained in database 16 to track activity related to posts which can be used for filtering, sorting, and maintaining the post, as well as tracking activity related to the post and relating that activity to particular users.

Each user of the system 10 including the social network has access to the statistic feed and can filter it in his or her way to populate and view specific types of post according to their specific desires. The feed can be filtered in a number of ways, the first being based upon other users that the user is following, the second being based upon the popularity of posts, the third by ranking of posts, the fourth being based upon post trending, the fifth being based upon tags, the sixth being based upon game tags, and the seventh being based upon users. One of ordinary skill in the field will readily appreciate that the feed may be filtered as based upon a number of different criteria and the invention is not limited to only those mentioned above.

When filtering as based upon followers, posts that are generated by other users that a user is following will be populated in that user's statistic feed in chronological order. When filtering as based upon popularity, posts are populated in the statistic feed by the number of ratings and comments over a selected period of time. The posts with the higher number of ratings and comments are listed higher in the statistic feed. When filtering by most liked, posts are listed by the ratio of favored rankings to unfavored rankings over a selected period with the highest ratios being listed first. When filtering by trending, posts are listed by the number of ratings and comments received over a predetermined period of time, for example, within the last 30-mins. When filtering as based upon tags, the posts are listed by the metadata tags (qtool control tags). When filtering as based upon game tags, posts are listed by upcoming games. When filtering as based upon user, posts are listed by selected users.

Filtering may be done by clicking, selecting or otherwise indicating specific filters, such as, for example displayed tags, user names, followers, etc. Filter may also be done using a search function, where a user may enter into a specified input box within the GUI a number of keyword search terms to search for posts that related to the keyword terms as a function of the metadata tags for each post.

It's important to note that users do not have to solely use a search bar to look for statistics with specific tags. They can also use a tool similar to that of the Statistic Creation Manager. Instead of allowing users to create statistics, however, the Statistic Search Manager allows users to search for statistics in the Feed based on specific tags. The Statistic Search Manager has the same query controls as the Statistic Creation Manager, however the Search Manager works to populate the Feed based on the criteria (aka tags, qtool controls) selected by the user. As the user selects more criteria, the Feed continues to populate to reflect statistics that match all of the specified criteria. The Statistic Search Manager would either appear above the Feed, or as an overlay to the Feed so that users can view what statistics are being populated as they select criteria. The Statistic Search Manager could also be incorporated into the Statistic Creation Manager, thereby providing a feed of statistics matching the user's selection criteria as he creates a statistic.

User Manager

User Manager 26 module or software code segment creates and tracks all users of the system 10. User Manager operates to maintain information related to the creation and tracking of system user, and user customization information. With reference to FIG. 8, for example, user information can include user name 800, first name 802, last name 804, email address 806, city 808, country 810, date of birth 812, gender 814, favorite sport 816, favorite team 818, followers 820, following 822, post count 824, and a unique user id 826.

With reference to FIG. 10, additional user information can include followers username 1000 and following username 1002 which is related to the user information by the unique user id and includes all of the usernames of that user's followers, and all of the usernames of who that user is following. The totals are represented in followers 820 and following 822.

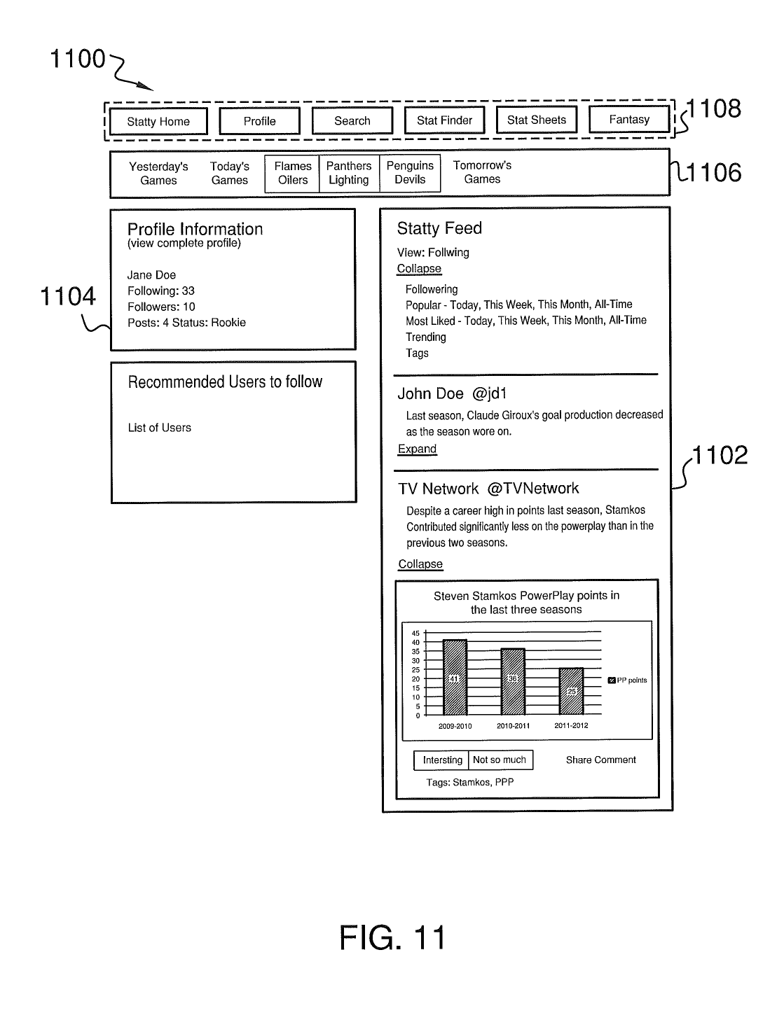

In preferred embodiment, the software of the invention is accessed through the Internet 19 using computing devices 18. As will be appreciated by one of ordinary skill in the art, the Internet comprises numerous numbers of computing devices and communication networks that are interconnected through communication links. The computer program for creating and sharing sports statistics is accessed via a web page, and is described in more detail below with reference to FIG. 11. In FIG. 11, there is representatively illustrated a home website and GUI interface 1100 generated by the software of the system 10. The exemplary home website includes the statistic feed 1102 of statistic posts, profile pane 1104 which displays information relative to the user, information/news pane 1106, and a website navigation pane 1108 including links to various other sections of the website.

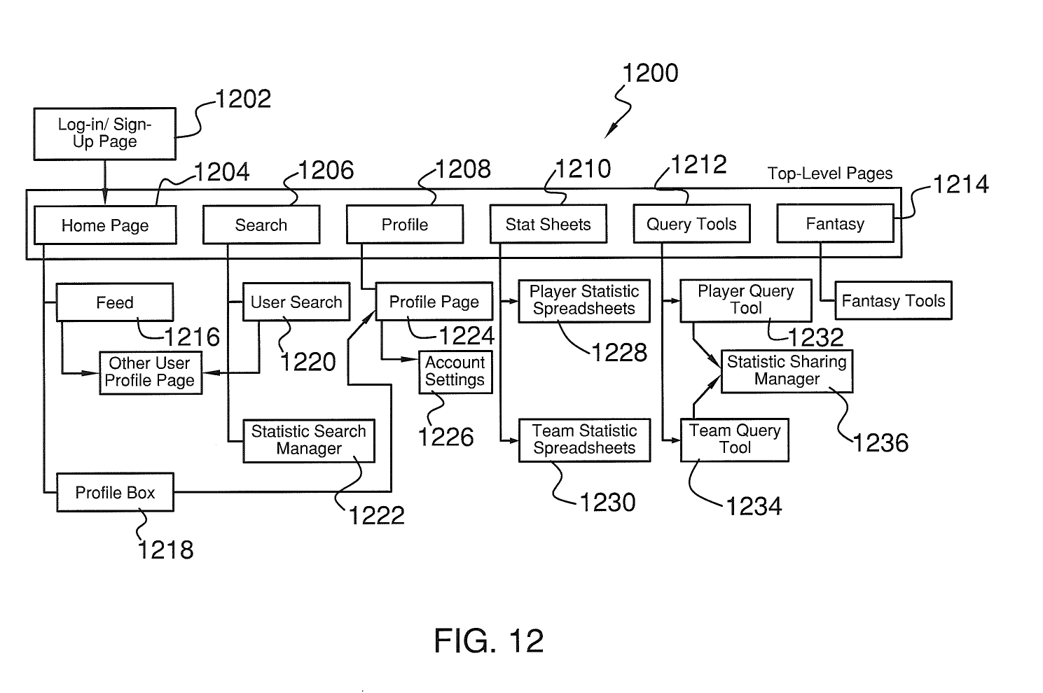

With reference to FIG. 12, there is illustrated an exemplary website architecture 1200 of the website the system 10 of the invention, wherein arrowed lines represent hyper-links to pages of the website. It is contemplated that top level pages would include user login 1202, home 1204, search 1206, profile 1208, stat sheets 1210, Query Tools 1212 and fantasy 1214.

Homepage 1204 contains the Feed 1216 and Profile Box 1218. The Feed 1216 contains Posts. Users can click the usernames of Post creators in order to link to the Post creator's user profile (named Other User Profile Page to distinguish it from a user's own Profile Page). Profile Box 1218 contains basic information about the user who is logged in—how many followers the user has, how many users the user is following, and how many posts the user has created. Clicking anywhere in the Profile Box links the user to her own Profile Page. Other User Profile Page: A user's profile page contains a Feed of her Posts, all well as her profile information such as how many followers she has, how many users she is following, and how many Posts she has created. Users also have the option to share information such as their location and favorite sports teams (see User Information Database Structure Diagram for all potential profile info that could be presented on this page).

The Search Page 1206 contains the User Search 1220 and the Statistic Search Manager 1222. User Search 1220 is a simple type-in search bar. Returned results come in the form of usernames, which users can click in order to link to that user's profile page (Other User Profile Page). Statistic Search Manager 1222, described above, allows users to search for Posts based on tags. Returned result is the Feed filtered by search criteria.

Profile 1208 contains the user's Profile Page 1224. Profile Page 1224 contains the user's own Posts and profile information (see User Information Database Structure Diagram for all potential profile info that could be presented on this page). A link to Account Settings 1226 allows user to edit their account and profile information.

Stat Sheets 1210 contains a page with a default view of team and player rankings This page provides links to Player Statistic Spreadsheets 1228 and Team Statistic Spreadsheets 1230. Player Statistic Spreadsheets 1228 provide for various views of player statistics organized in datasheets. Team Statistic Spreadsheets 1230 provide for various views of team statistics organized in datasheets.

Query Tools 1212 contains a description of both the Player 1232 and Team 1234 Query Tools and provides links to both. As discussed above, the Player Query Tool allows users to create player statistics and the Team Query Tool allows users to create team statistics

Statistic Sharing Manager 1236, as discussed above, allows users to edit the written and pictorial elements of their player or team statistic. The Sharing Manager 236 also posts the created statistic to the Feed once the user has made the necessary edits.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device.

One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented system for generating and sharing sports statistics on a website, comprising:
a statistic creation manager configured to access a database of sports data, to receive user selections as a function of the sport data, and upon receiving the user selections to generate a sports statistic as a function of those user selections; and
a statistic feed manager configured to tag the sports statistic with one or more received user selections to permit display of the sports statistic on the website as a function of the tag.

2. The system of claim 1, wherein said statistic creation manager comprises a player query.

3. The system of claim 1, wherein said statistic creation manager comprises a team query.

4. The system of claim 1, further comprising:
statistic sharing manager configured to control the display format of the sport statistic.

5. The system of claim 1, further comprising:
a statistic search manager configured to present a user with search terms as a function of one or more tags.

6. A method for generating and sharing sports statistics on a website, comprising:
accessing a database of sports data;
receiving user selections as a function of the sports data;
generating a sports statistic upon receiving user selections as a function of the received user selections; and
tagging the sports statistic with metadata to facilitate indexing and searching of the sports statistic, the metadata comprising one or more of the received user selections.

7. The method of claim 6, wherein the receiving comprises receiving player query selections.

8. The method of claim 6, wherein the receiving comprises receiving team query selections.
